(19) United States
(12) Patent Application Publication
(10) Pub. No.: US 2012/0258318 A1
(43) Pub. Date: Oct. 11, 2012

(54) ASSEMBLY OF TWO SUBSTRATES BONDED BY A FLEXIBLE POLYMER, AND METHODS FOR ASSEMBLY AND DISMANTLING BY MEANS OF MIGRATION OF SAID BONDED ASSEMBLY

(75) Inventors: Marie-Pierre Foulc, Salles (FR); Tomas Bergara, Bordeaux (FR); Maxime Olive, Talence (FR)

(73) Assignee: RESCOLL, Pessac (FR)

(21) Appl. No.: 13/517,318

(22) PCT Filed: Dec. 24, 2010
(86) PCT No.: PCT/FR2010/052917

§ 371 Date: Jun. 20, 2012

(30) Foreign Application Priority Data
Dec. 29, 2009 (FR) 0959643

(51) Int. Cl. C08L 75/04; B32B 38/10; C08L 83/00; C08K 5/23; C08K 5/092; B32B 37/12; B32B 7/12

(52) U.S. Cl. 428/423.1; 156/327; 156/711; 156/331.7; 156/329; 428/447; 524/190; 524/321

(57) ABSTRACT

An assembly (20) includes a first substrate (10) and a second substrate (12) bonded by at least one joint (14), characterized in that the joint (14) is made of a polymer material with a Young's tensile modulus value at 25° C. of between 0.1 and 500 MPa, and includes at least one migrating agent suitable for migrating up to at least one of the interfaces of the joint (14) in order to generate interfacial detachment. A composition enabling the bonding of the assembly, a method for mounting the assembly by bonding, and a method for dismantling the bonded assembly by way of migration and creation of an interfacial detachment by localized heating are also described.

This invention relates to an assembly of two bonded substrates as well as the composition that makes it possible to bond this assembly.

The invention also covers a method for assembly of this assembly by bonding and a method for disassembly of this migration-bonded assembly and creation of an interfacial detachment.

In the industry, there are more and more assemblies produced by bonding with compositions that are perfectly suited to the necessary conditions of mechanical strength, resistance to temperatures experienced, and to numerous other parameters that are both physical and chemical.

The thus bonded substrates provide total satisfaction in the resulting assembly.

In contrast, problems occur when the thus assembled substrates have to be disengaged, for example for the purpose of changing one or the other of the assembled substrates.

Unlike mechanical connections, which allow simple disassembly by screw or rivet, to provide an example, it is difficult to disassemble the bonded substrates without damaging them.

In addition, in the case of bonding, if disassembly is ensured, it is also necessary to provide for the reassembly of a new substrate instead of the defective substrate. The surfaces then should be able to receive this new bonded connection.

The bonding connections are produced by preparing the surfaces to be connected by bonding so that they have a suitable surface condition.

The seal is arranged on at least one of the surfaces, the substrates are positioned under pressure, and the hardening of the glue is produced by heating, by radiation emission or by an associated catalyst, to provide examples. The hardening of the glue can also take place under the action of moisture or at ambient temperature. No matter what happens, the substrates are thus made integral.

If the separation of this connection between two substrates is mechanical by attempting to degrade only one of the two substrates, it is noted that in the majority of cases, at least one of the substrates is degraded, and even both.

In addition, in the event that separation is successful, the substrate that is kept intact has a surface condition that precludes a new connection by bonding or at least requires a significant work of surface treatment.

One approach consists in providing a controlled reversibility of the bonded connections with three means for implementing this reversibility, by chemical, physico-chemical or physical means.

The chemical method uses seals with polymer bases whose structure can be modified or destroyed by outside actions such as heat, radiation or eletromagnetic fields.

It thus is possible to use a polymer that comprises a chemical chain with groups that can form a chain by polymerization under the action of a given wavelength, while the separation is achieved, at the proper time, by degradation of this chain under the action of another determined wavelength.

Nevertheless, such products have relatively weak adhesion performance levels and are connected to very specific applications.

Applications in the attachment of electronic components are known, so as to allow their removal and their quick replacement, but it is also understood that the required mechanical performance levels, for example, are low.

The physico-chemical method consists in combining thermoplastic resins with thermosetting resins that are known for their mechanical performance levels. Since thermoplastics have the capacity to lose a large portion of their properties under the action of heat, the connection by a seal that comprises a combination of a thermosetting agent and a thermoplastic can turn out to be detachable by destruction of the seal in its entirety. In this case, disassembly is possible, but the two substrates generally support a portion of this degraded seal, and it is necessary to remove at least the remaining portion of the seal on the substrate that is to be reused.

It is also possible to note that the performance levels of thermosetting agents are degraded by the presence of the thermoplastic, especially since the substrates work as a function of temperature, even when they remain far from the ranges of degradation temperatures.

The physical method consists in introducing into the adhesive composition itself, furthermore known for its adhesive capacities, additives that under outside stimulation, often heat, are able to destroy the cohesion of the seal in its entirety.

There are numerous applications that require the separation of two bonded substrates, increasingly for purposes of recycling. Actually, to make it possible to classify materials of different types and to recycle them independently—for example a composite material and a metal reinforcement, such as an automobile window—it is necessary to perform this type of separation. The prior art also systematically provides for the separation of two bonded substrates, with the degradation of the seal ensuring the connection, in its entirety. This implies that in these cases depicted, the detached surfaces are contaminated by the adhesive residue and require a rather cumbersome follow-on treatment to allow possible reuse.

An illustration of such prior art is the Patent Application WO 00/75254 that describes an arrangement with a polymer-based seal that includes microcapsules that contain solvent-type expansion agents with a low boiling point that cause, under the action of the direct heat and with adequate power, a loss of cohesion of the seal that thus facilitates disassembly. One particular application is the installation and removal of vehicle windshields.

It is noted that these microspheres can be used within adhesion primers, in the case of automobile windows, for example. After activation and expansion of microcapsules within the primer, the latter has lost all of its cohesion, and disassembly is possible. However, the primer-supporting substrates are contaminated and have to be treated again so as to be able to be reglued.

One approach to these different problems was provided in the Patent Application EP-1,814,935, which describes a method for assembly of substrates by bonding with a polymer matrix that comprises a migrating agent, as well as a method for disassembly of the bonded assembly, which consists in supplying energy destined for the migrating agent in such a way as to cause its migration to at least one of the polymer matrix/substrate interfaces for generating a layer of low cohesion and for separating the elements.

The migrating agents such as pTSH melt and migrate up to the interface and then decompose there to induce the interfacial detachment.

Such a disassembly method allows the disassembly without degrading one or the other of the substrates and makes it possible to separate the two substrates by obtaining a surface without adhesive residue of at least one of the substrates, optionally ready to be assembled again with a new substrate.

Since then, it has been discovered that it was also possible to use migrating agents that do not melt ahead of time, but that, once activated, generate gases directly in the volume of the polymer matrix that is used as a seal, gases that migrate toward the interface.

However, based on the polymer matrix-based composition that is used to bond the substrates, the gases that are generated do not migrate in the same way, and the gas concentration at the seal/substrate interface is not always adequate for allowing the detachment.

This is why the objective of the invention is to remedy these drawbacks and to propose a particular composition that makes possible the assembly of two substrates by bonding, an assembly that can always be disassembled by a specific method.

For this purpose, the object of the invention is a composition that is intended to be used as a seal to bond two substrates, then detachable by localized heating, consisting of a polymer material that has a Young's modulus value of tensile strength at 25° C. of between 0.1 and 500 MPa and comprising at least one migrating agent that can migrate up to at least one of the interfaces of the seal for generating an interfacial detachment.

“Interfacial detachment” is defined as the separation of assembled surfaces at the bonded interfaces.

Likewise, “localized heating” in terms of the invention is defined as any heating method that makes it possible to heat at at least one of the interfaces of the seal, unlike a heating in its entirety, which takes place on the entire glue seal.

The invention also covers the assembly that can be detached by localized heating that is produced using this composition, as well as a method for assembly and a method for disassembly particular to this assembly, which necessarily makes it possible to detach the two substrates.

The invention will now be described in detail according to a particular non-limiting embodiment.

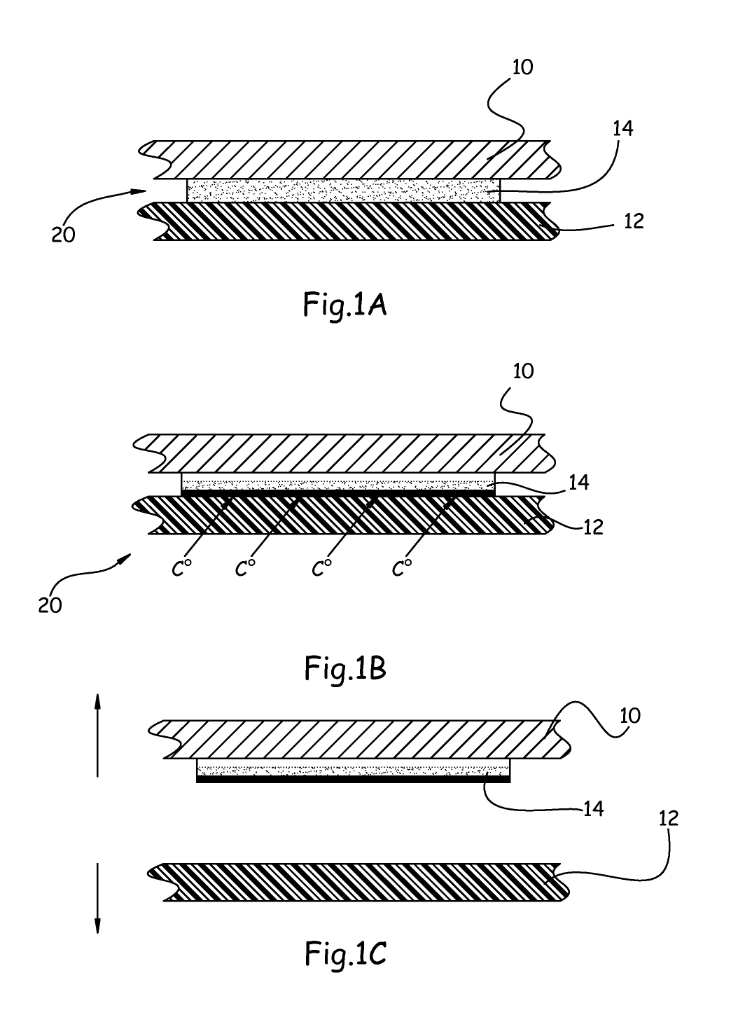

FIGS. 1A to 1C diagrammatically show an assembly as it is presented during the contact, during the supply of localized heat for the migration, and during the disassembly.

According to a first aspect, the purpose of the invention is an assembly 20, which comprises a first substrate 10 and a second substrate 12 that are bonded with at least one seal 14, as shown in FIG. 1A. The seal 14 consists of polymer material that has a Young's modulus value of tensile strength at 25° C. of between 0.1 and 500 MPa, i.e., a flexible polymer material, and that comprises at least one migrating agent that can migrate up to at least one of the interfaces of the seal 14 to generate an interfacial detachment under the action of the heat.

The assembly 20 can be disassembled by localized heating between the seal 14 and one of the substrates 10, 12.

Preferably, this is a polymer material that has a Young's modulus value of tensile strength at 25° C. of between 0.1 MPa and 100 MPa.

The seal 14 can be an adhesive of the known resin-based type that has a Young's modulus value of tensile strength at 25° C. of between 0.1 and 500 MPa such as a PUR (polyurethane) resin.

In terms of the invention, seal can also mean an adhesive primer, i.e., a layer, of the same type as the polymer that is used for the adhesive (having a Young's modulus value of tensile strength at 25° C. of between 0.1 and 500 MPa), applied before the adhesive and whose thickness is several tens of microns. It may involve, for example, paint or coatings.

It is considered that the presence of the first substrate 10 and the second substrate 12 with the seal 14 defines two interfaces, one between this seal and the first substrate, and the other between this seal and the second substrate.

Nevertheless, it is possible that the assembly 20 comprises several seals, for example two different adhesives or one adhesive and one primer.

In the case of two superposed seals, connected to one another, and with this unit itself being connected to two substrates, a supplementary interface between the two seals is defined.

An interface between two seals or between one seal and one substrate is considered to be equivalent.

At least one of the seals includes at least one compound that can migrate into the matrix of the seal to generate an interfacial detachment at at least one of the interfaces of said seal with one of the substrates or with another seal.

A second aspect of the invention relates to the composition that is designed to use the seal 14 for the assembly 20.

This composition comprises:
A polymer base that has a Young's modulus value of tensile strength at 25° C. of between 0.1 and 500 MPa, and
At least one migrating agent.

“Polymer base” is defined as the binder or skeleton that constitutes the adhesive.

Among the polymer bases that are particularly suitable for this invention, it is possible to cite in particular the elastomers, in particular the polyurethane (PUR) matrices, and silicone matrices. These matrices, once polymerized, are flexible.

“Migrating agent” is defined as at least one molecule, which, once activated, is able to migrate to at least one of the interfaces of the seal 14 to generate an interfacial detachment under the action of heat.

Preferably, this is an agent that, subjected to a certain heat, decomposes and generates gases that migrate toward at least one interface to produce stresses there and to induce a detachment.

The migrating agent can be selected from among the chemical expanding agents.

Preferably, the migrating agent is a polycarboxylic acid or azodicarbonamide.

According to a preferred embodiment, the migrating agent is present at between 2.5 and 50% by weight of the polymer base, even more preferably between 2.5 and 30%. This proportion is particularly suitable for the detachment of flexible substrates that consist of a polymer material that has a Young's modulus value of tensile strength at 25° C. of between 0.1 MPa and 500 MPa.

This composition can be used as a seal 14 for producing an assembly 20 by implementing the following stages:
Placing at least said composition between a first substrate 10 and a second substrate 12,
Pressing the two substrates 10, 12 against one another, and
Polymerizing the composition to form a seal 14 and to produce the bonded assembly of the two substrates 10, 12.

The thus obtained assembly 20 can be disassembled by the implementation of a method that comprises the following stages:
Heating locally at the interface between the seal 14 and a substrate 10, 12 at the activation temperature of the migrating agent that is incorporated in the seal 14 so as to generate gases and cause their migration up to the interface of the seal 14 with the substrate 10, 12, thus producing an interfacial detachment, and
Separating the elements facing the interfacial detachment.

The localized heating stage can be carried out by means that are suitable for assembled substrates, such as, for example, with an infrared lamp if one of the substrates is made of glass or by induction for the case of a main body or else using a heating wall in accordance with one of the substrates.

Without the localized heating, for example, with a heating in its entirety in an oven, the two substrates cannot be detached because of the flexible polymer material used in the composition. Actually, with heating in its entirety, the gases that are generated within the volume are not at an adequate concentration at the interface, and an interfacial detachment cannot be created.

The temperature for the detachment is preferably selected between 150 and 220° C.

Advantageously, the localized heating that is associated with the selection of the particular polymer base according to the invention with a low elasticity modulus value makes it possible to create bubbles on the surface of the seal, which burst under the action of gases, which has the effect of releasing gases at the interface in an adequate concentration to allow the interfacial detachment.

The disassembly is diagrammatically shown in FIGS. 1B and 1C. The interfacial detachment is generated in FIG. 1B by the supply of localized heat, and the two substrates are separated from one another in FIG. 1C, with the seal able to remain on one of the two substrates.

The invention can be illustrated by a non-limiting example of a glass-metal assembly that is bonded with a seal, a monocomponent polyurethane (adhesive) incorporated into 5% azodicarbonamide (migrating agent included in the adhesive).

Two types of tests have been conducted on this assembly in comparison with an assembly that is made with a standard glue (uncharged monocomponent polyurethane).

### Test 1: Peeling Test

This peeling test is inspired by automobile standard D51 1709 (peeling of an adhesive strip that is glued to a glass substrate).

A semi-assembly (without metal to be able to peel the strip) that is assembled according to the invention and a semi-assembly (without metal) that is assembled with a standard glue are activated.

The activation of the samples is carried out using an infrared lamp placed facing the outside surface of the glass. This makes it possible to heat locally at the surface of the glue seal located on the glass side.

The results that are obtained are presented in the table below:

| | Without Activation | After Thermal Activation |
|---|---|---|
| Standard Assembly | Cohesive Rupture | Cohesive Rupture |
| Assembly According to | Cohesive Rupture | Adhesive Rupture (No |
| the Invention | | Adhesion to the Glass) |

### Test 2: Detachment Test

For this test, the glue seal between the glass and the metal for the assembly according to the invention and for the standard glue is characterized by:
A thickness of 4 mm,
A length of 50 mm, and
A width of 10 mm.

The activation of the samples is carried out using an infrared lamp that is placed facing the outside surface of the glass. This makes it possible to locally heat the surface of the glue seal that is located on the side of the glass.

The results that are obtained for measuring the detachment force of N are presented in the table below:

| | Without Activation | After Thermal Activation |
|---|---|---|
| Standard Assembly | 1,700 | 1,200 |
| Assembly According to | 1,920 | 130 |
| the Invention | | |

It is noted that after activation by localized heating, the samples that are assembled with a seal according to the invention exhibit a face of adhesive rupture, characteristic of the location of the detachment and the action of gases at the interface. The detachment can be seen during the activation (appearance of a void between the seal and the substrate). The value that is measured during the detachment test (130) corresponds to the low residual stability of the seal on the glass.

1. Assembly (20), comprising a first substrate (10) and a second substrate (12) that are bonded with at least one seal (14), which can be disassembled by localized heating at the interface between the seal (14) and one of the substrates (10, 12), characterized in that said seal (14) consists of polymer material that has a Young's modulus value of tensile strength at 25° C. of between 0.1 and 500 MPa, and comprises at least one migrating agent that can migrate up to at least one of the interfaces of the seal (14) for generating an interfacial detachment under the action of heat.

2. Composition that is designed to be used as a seal (14) for the assembly (20) according to claim 1, wherein it comprises:
A polymer base that has a Young's modulus of tensile strength at 25° C. of between 0.1 and 500 MPa, and
Between 2.5 and 50% by weight of the base of at least one migrating agent.

3. Composition according to claim 2, wherein the migrating agent is a polycarboxylic acid.

4. Composition according to claim 2, wherein the migrating agent is azodicarbonamide.

5. Composition according to claim 2, wherein the polymer base is a polyurethane matrix.

6. Composition according to claim 2, wherein the polymer base is a silicone matrix.

7. Method for assembling an assembly (20) according to claim 1, which comprises carrying out the series of the following stages:
Placing at least one composition comprising a polymer base that has a Young's modulus of tensile strength at 25° C. of between 0.1 and 500 MPa, and between 2.5 and 50% by weight of the base of at least one migrating agent, between a first substrate (10) and a second substrate (12),
Pressing the two substrates (10, 12) against one another, and
Polymerizing the composition to form a seal (14) and to produce the bonded assembly of the two substrates (10, 12).

8. Method for disassembling an assembly (20) according to claim 1, comprising the following stages:
Heating locally at the interface between the seal (14) and a substrate (10, 12) at the activation temperature of the migrating agent that is incorporated into the seal (14) so as to be able to generate gases and cause their migration up to the interface of the seal (14) with the substrate (10, 12), thus producing an interfacial detachment, and
Separating the elements facing the interfacial detachment.

9. Composition according to claim 3, wherein the polymer base is a polyurethane matrix.

10. Composition according to claim 4, wherein the polymer base is a polyurethane matrix.

11. Composition according to claim 3, wherein the polymer base is a silicone matrix.

12. Composition according to claim 4, wherein the polymer base is a silicone matrix.

13. The method according to claim 7, wherein the migrating agent is a polycarboxylic acid.

14. The method according to claim 7, wherein the migrating agent is azodicarbonamide.

15. The method according to claim 7, wherein the polymer base is a polyurethane matrix.

16. The method according to claim 7, wherein the polymer base is a silicone matrix.
